(19) United States
(12) Patent Application Publication
(10) Pub. No.: US 2025/0023854 A1
(43) Pub. Date: Jan. 16, 2025

(54) PROCESSING ELECTRONIC MESSAGES

(71) Applicant: Capital One Services, LLC, McLean, VA (US)

(72) Inventors: Jerry WU, McLean, VA (US); Tyler MAIMAN, Melville, NY (US); Bryant YEE, Silver Spring, MD (US)

(73) Assignee: Capital One Services, LLC, McLean, VA (US)

(21) Appl. No.: 18/352,231

(22) Filed: Jul. 13, 2023

(51) Int. Cl. H04L 9/40; H04L 51/21

(52) U.S. Cl. CPC H04L 63/08; H04L 51/21; H04L 63/20

(57) ABSTRACT

Methods and systems are described herein for processing electronic messages. A processing system may be used to facilitate the processing. The system may receive a plurality of electronic messages associated with a user and may input electronic messages into a machine learning model to obtain electronic messages that contain authorization packages for entities, wherein the machine learning model is trained to identify electronic messages that contain authorization packages. The system may determine based on the electronic messages an authorization package comprising a token identifier, and entity identification data identifying an entity. The system may determine an application programming interface for communicating with an entity device and user identification data used by the user to access the entity device. The system may then transmit a command for executing a first operation at the entity device, wherein the command includes the user identification data and the authorization package.

### BACKGROUND

Electronic communications such as email (e-mail), text messages, and others have become ubiquitous in our society. People use, for example, email to communicate in a variety of ways. The simplest use of electronic communications involves sending messages. However, other users of emails have become prevalent. For example, various information may be sent (e.g., in a form of an attachment). Some of those types may include images, documents, and/or other information types. Another way people use email is for communicating various reminders, appointments, or other types of data that needs a confirmation. Those communications may be sent by online scheduling systems.

### SUMMARY

Online scheduling systems, such as those used to schedule medical appointments with physicians, often require user confirmation of attendance, e.g., via electronic messages. For example, often after users schedule an appointment, such as through a user's account via an online platform for an entity (e.g., hospital website, application, etc.), a confirmation or verification message (e.g., email, text message) is sent to users both to confirm that a user can attend and to verify the identity of the user to whom the account belongs.

While verification is often important to ensure that appropriate parties are scheduling appointments, there are many difficulties with requiring such confirmation for reserving timeslots for scheduled appointments. In many cases, these messages are often not reliable as emails and/or texts may be filtered or lost in spam folders. Additionally, some users may not check electronic messages with frequency, leading to delays in the confirmation process or missed appointments and reservations. In certain examples, these confirmation messages are not sent out immediately to the user upon initial scheduling, which may add to delay.

Furthermore, users often reserve time slots or schedule appointments using multiple different platforms for many differing purposes, exacerbating the complexity and difficulty of managing confirmation and verification at different entities. For example, a user may book reservations for restaurants, exercise classes, doctor's appointments, etc. for different entities such as restaurants, gyms, and hospitals using different reservation platforms. It may be difficult for users to confirm each reservation or appointment in a timely manner by reviewing electronic messages, traversing to the platform via the electronic message, and confirming the appointment. Accordingly, a mechanism is desired that would enable individual users to authenticate and/or procure resources, such as a time slot for an appointment, for one or more platforms, without the need for multiple interactions by the user and without necessitating several authentication steps between several parties.

One mechanism to enable individual users to authenticate and/or procure resources (e.g., such as a time slot at a restaurant) by processing electronic messages includes machine learning. Machine learning techniques can be used to identify messages including authorization packages, e.g., which may be used to enable a user to reserve a resource such as a time slot or appointment time. Therefore, methods and systems are described herein for processing electronic messages using machine learning. A processing system may be used to perform operations described herein.

The processing system may receive a plurality of electronic messages associated with a user, such as emails on an email server associated with a user's account. One or more of the electronic messages may include an authentication package, which may be used to enable a user to reserve a resource such as a time slot or appointment time. For example, as described herein, electronic messages may include options for confirming a user can attend and/or verifying the identity of the user prior to reserving an appointment time for the user. The processing system may receive the electronic messages, such as emails of a user, texts of a user, etc., from a server (e.g., an email provider's server).

The processing system may input the plurality of electronic messages into a machine learning model, e.g., to identify electronic messages of the input plurality of electronic messages that contain one or more authorization packages for one or more entities (e.g., restaurants, hospitals, etc.). The machine learning model may be trained to identify electronic messages that contain authorization packages which enable individual users to procure resources (e.g., such as a time slot at a restaurant). For example, the model may be trained using a training dataset including electronic messages and label data for each electronic message indicating (1) whether each electronic message includes a corresponding authorization package and (2) corresponding entity identification data.

The processing system may determine based on the one or more electronic messages (1) an authorization package comprising a token identifier, and (2) entity identification data identifying an entity associated with the authorization package. For example, based on the emails or text messages requesting confirmation for scheduling an appointment, the system may determine entity identification data, such as a hospital name, or hospital platform through which the appointment was made, and may also include an authorization package enabling the user to confirm the appointment. The authorization package may include a token identifier, which may be a unique identifier that identifies an instance associated with the user. In some examples, the unique identifier may be used in communications with a device of the entity, such that the entity can identify a resource or time slot that a user is intending to confirm or verify, and/or the like.

The processing system may determine based on the entity identification data, (1) an application programming interface (API) for communicating with an entity device and (2) user identification data used by the user to access the entity device. For example, if the email is from a hospital platform requesting confirmation prior to booking an appointment, the processing system may identify the hospital platform and an API for communicating with the hospital platform. The processing system may query the user for user credentials (e.g., user identification data) in order to communicate with the entity.

The processing system may transmit a command for executing a first operation at the entity device, wherein the command includes the user identification data and the authorization package in a format corresponding to the application programming interface. For example, the command to execute the first operation may be a command to confirm a reservation or appointment, and the command may include the user identification data and the authorization package so that the entity device may confirm that the appropriate user is confirming and has authorization to do so.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for processing electronic messages using machine learning, in accordance with one or more embodiments.

FIG. 2 shows an illustrative diagram for storing authentication package data of electronic messages at a storage application, in accordance with one or more embodiments.

FIG. 3 shows illustrative components of a system used for processing electronic messages, in accordance with one or more embodiments.

FIG. 4 shows a flowchart of the steps involved in processing electronic messages using machine learning, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Techniques disclosed herein may be used to process emails, such as those containing gift cards. For example, emails of a user may be obtained by the system (e.g., locally and/or remotely) and input into a machine learning model trained to identify emails with gift cards (e.g., based on the text, images, layout, etc. of the email). The emails with gift cards may then be used to determine the gift card supplier and a gift card code. Based on the entity that supplied the gift card, such as a store, the system may determine (1) an application programming interface for communicating with an entity device (e.g., entity's server) and (2) user identification data used by the user to access the entity device, such as a user account at the entity website. The system may then transmit a command for executing an operation at the entity device, such as adding the gift card balance or code to the user's account. The system may include the user identification data and the gift card data. Described herein are methods and descriptions for performing processing of emails to perform operations. In other examples, techniques disclosed herein may be used to process other electronic messages as described herein.

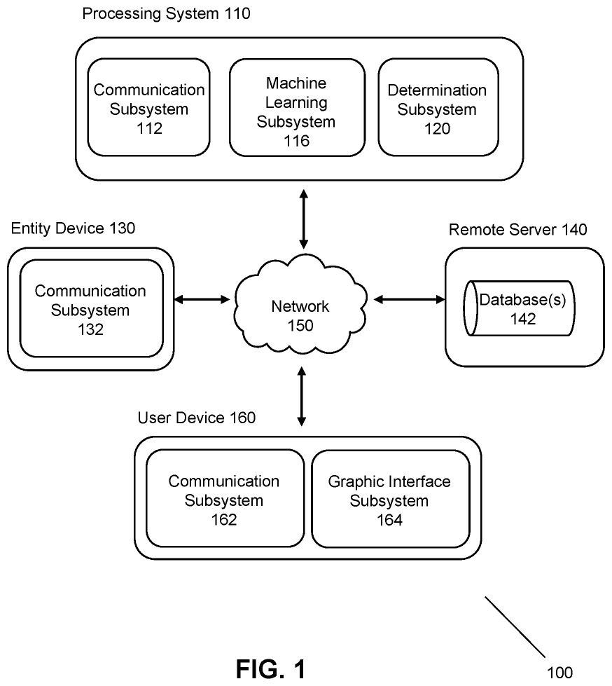

FIG. 1 is an example of environment 100 for processing electronic messages of a user. For example, environment 100 may be used to process electronic messages using machine learning. Environment 100 includes processing system 110, entity device 130, user device 160, and remote server 140. Processing system 110, entity device 130, user device 160, and remote server 140 may be in communication via the network 150. Network 150 may be a wired and/or wireless connection such as a local area network, a wide area network (e.g., the Internet), or a combination thereof.

Processing system 110 may execute instructions for processing electronic messages to enable individual users to procure and/or redeem resources, such as a time slot for an appointment or value stored on a gift card, for one of more platforms, without the need for multiple interactions by the user and without necessitating several authentication steps between several parties. Processing system 110 may include software, hardware, or a combination of the two. For example, processing system 110 may be hosted on a physical server or a virtual server that is running on a physical computer system. In some embodiments, processing system 110 may be configured on user device 160 (e.g., a laptop computer, a smartphone, a desktop computer, an electronic tablet, or another user device). In some examples, the processing system 110 may include a plug-in and may be stored locally. Processing system 110 may access remote servers, such as remote server 140 via network 150.

The processing system 110 may include components such as communication subsystem 112, machine learning subsystem 116, and determination subsystem 120, which may be used to process electronic messages of a user. In some embodiments, processing system 110 may receive a plurality of electronic messages using communication subsystem 112. Communication subsystem 112 may include software components, hardware components, or a combination of both. For example, communication subsystem 112 may include a network card (e.g., a wireless network card and/or a wired network card) that is associated with software to drive the card. In some embodiments, communication subsystem 112 may receive electronic messages such as emails, text messages, etc. of a user. Communication subsystem 112 may pass at least a portion of the data included in the electronic messages, or a pointer to the data in memory, to other subsystems such as machine learning subsystem 116 and/or determination subsystem 120. Communication subsystem 112 may receive the electronic messages, e.g., via network 150, from a remote server 140, and/or a database 142 of remote server 140.

Machine learning subsystem 116 may be used to determine whether the electronic messages include authorization packages which enable individual users to procure resources. Machine learning subsystem 116 may include software, hardware, or a combination of the two. For example, machine learning subsystem 116 may be a physical server, or a virtual server that is running on a physical computer system. In some embodiments, processing system 110 and machine learning subsystem 116 may reside on the same hardware and/or the same virtual server/computing device.

The machine learning subsystem 116 may include one or more machine learning models trained to identify electronic messages with authorization packages (e.g., for enabling individual users to procure resources). For example, an authorization package as referred to herein may include an electronic mechanism that enables individual users to procure resources, such as an electronic gift card which enables a user to utilize value associated with the gift card to redeem goods or services, a voucher for a product, a reservation for a time slot, etc. Processing system 110 may input the plurality of electronic messages, e.g., passed from communication subsystem 112, into one or more machine learning models of machine learning subsystem 116 to obtain one or more electronic messages of the plurality of electronic messages that contain one or more authorization packages for one or more entities. For example, the machine learning subsystem 116 may be trained to identify electronic messages such as emails or text messages that include authorization packages such as gift cards or reservation confirmations.

The machine learning subsystem 116 may pass at least a portion of the output of the one or more machine learning models, or a determination made based on the output of the one or more machine learning models. For example, as a result of inputting the electronic messages into the machine learning models of the machine learning subsystem 116, the machine learning model(s) may output (1) a probability for each electronic message that each electronic message of the plurality of electronic messages includes at least one authorization package and/or (2) entity identification data associated with the at least one authorization package. In response to determining that the probability exceeds a threshold probability for an electronic message, the processing system 110 may determine that the electronic message of the plurality of electronic messages includes the at least one authorization package.

According to some examples, the one or more machine learning models of the machine learning subsystem 116 may be trained using one or more training datasets. For example, processing system 110 and/or the machine learning subsystem 116 of the processing system 110 may receive a training dataset (e.g., via network 150 and communication subsystem 112) comprising electronic messages and label data for each electronic message indicating (1) whether each electronic message includes a corresponding authorization package and (2) corresponding entity identification data. For example, the training dataset may include a plurality of emails containing, or not containing gift cards as well as a label for each indicating that they contain, or do not contain a gift card. The training dataset may also include emails with logos or specific entity names, labeled with the entity associated with the email. The processing system 110 and/or the machine learning subsystem 116 of the processing system 110 may train the machine learning model using the received training dataset.

As described herein, the machine learning subsystem 116 may pass at least a portion of the output of the one or more machine learning models, or a determination made based on the output of the one or more machine learning models to other subsystems such as communication subsystem 112 and/or determination subsystem 120. Processing system 110 may determine one or more electronic messages of the plurality of electronic messages including authorization packages and may pass the one or more electronic messages and/or data corresponding to the one or more electronic messages to determination subsystem 120.

Determination subsystem 120 may be used to determine and/or extract (1) the authorization package including a token identifier, and (2) entity identification data identifying an entity associated with the authorization package from electronic messages determined to include authorization packages (e.g., based on outputs from models of the machine learning subsystem 116). According to some examples, the authorization package may include a gift card. For example, the authorization package may include an electronic wrapper for a code (i.e., token identifier) that identifies the gift card. For example, when the entity issues the electronic gift card (e.g., authorization package), a unique code may be generated and associated with a value of the card. The code can be an alphanumeric series (e.g., of letters and numbers).

Determination subsystem 120 may include software, hardware, or a combination of the two. For example, determination subsystem 120 may be a physical server, or a virtual server that is running on a physical computer system. In some embodiments, one or more of communication subsystem 112, machine learning subsystem 116, and determination subsystem 120 may reside on the same hardware and/or the same virtual server/computing device.

Determination subsystem 120 may determine entity identification data, such as a name of an online retailer that issued the gift card or accepts the gift card as tender based on the emails or text messages including gift cards. In one example, determining the entity identification data may include extracting textual data from an electronic message and performing optical character recognition (OCR) on the textual data. For example, the electronic message (e.g., email) may include an image of a gift card. The determination subsystem 120 may perform OCR to identify a name of the entity on the gift card to determine an entity that issued the gift card.

Alternatively, or additionally, determining the entity identification data may include generating an image from an electronic message and inputting the image into an entity recognition machine learning model to obtain the entity identification data, wherein the entity recognition machine learning model has been trained to identify entities associated with electronic messages. The determination subsystem may then receive the entity identification data from the entity recognition machine learning model. For example, many entities such as online retailers that issue gift cards (and/or similar vouchers) may include logos or similar identifiers (such as font, color, etc.) that are identifiable or recognizable. The entity recognition machine learning model may be trained to identify the entity based on an image of the electronic message. This machine learning model may be a part of the determination subsystem or alternatively may be a part of the machine learning subsystem.

Determination subsystem 120 may also determine based on the entity identification data, (1) an application programming interface (API) for communicating with an entity device and (2) user identification data used by the user to access the entity device. As referred to herein, user identification data used by the user to access the entity device may include any user identification used by the entity to verify or authenticate a user. For example, the user identification information may be a username, password, and email address associated with a user account at the entity platform. For example, if the email is from a hospital platform requesting confirmation prior to booking an appointment, the processing system may identify the hospital platform and an API for communicating with the hospital platform. The processing system may query or prompt the user for user credentials (e.g., user identification data) in order to communicate with the entity. Alternatively or additionally, the processing system may have access to user credentials (e.g., such as saved credentials).

The processing system may generate and/or transmit a command for executing a first operation at the entity device. The command may include the user identification data and the authorization package in a format corresponding to the application programming interface. For example, the command to execute the first operation may be a command to confirm a reservation or appointment, the command may include the user identification data and the authorization package so that the entity device may authenticate that the appropriate user is confirming the operation, and has authorization to do so. The command to execute the first operation may include an instruction for inserting the authorization package into user data of the user within the entity device. For example, the authorization package may be a gift card, and the instruction may be for inserting the gift card information into a user's account. The communication subsystem 112 may access the data included in the command such as the user identification information and authorization package, e.g., from the determination subsystem 120, to generate the command.

According to some examples, processing system 110 may receive from entity device 130 via the network 150, a message indicating that execution of the command was successful, e.g., an authorization package was successfully inserted into the user data within the entity device. For example, the processing system may transmit a message indicating that a gift card was successfully inserted into a user's account at the entity, e.g., an online retailer. In some examples, the message may include a validity indicator for the authorization package, which may indicate that the authorization package was valid, and/or successfully inserted. The validity indicator may then be generated for display (e.g., on graphic interface subsystem 164) at a user device 160 (e.g., mobile phone, etc.).

As described herein, the validity indicator may indicate that the authorization package is valid. The processing system 110 may transmit the user identification information, as well as the authorization package to the entity device 130, e.g., via their respective communication subsystems and network 150. Entity device 130 may then determine whether or not the authorization package is valid. For example, the entity device may determine whether the user identified with the user identification data is allowed to use the authorization package, whether the authorization package has expired, whether the authorization package is for the entity, and/or the like. In some examples, the validity indicator may indicate that the authorization package is not valid.

According to some examples, rather than inserting the authorization package into user data of the user within the entity device, e.g., inserting the gift card value or gift card code into a user's account at the entity, the processing system 110 may store the authorization package data on a storage application, such as a digital wallet, e.g., independent from the entity and entity device. As referenced herein, a storage application may be used to enable users to securely store and manage digital assets. In one example, processing system 110 may initiate a storage application configured to store authorization package data of a plurality of authorization packages associated with the user and may update the storage application with the authorization package. The storage application may be stored at the user device 160, or the storage device may be stored on the remote server 140 or processing system 110 and the user device 160 may access the storage application via communication subsystem 162 and network 150.

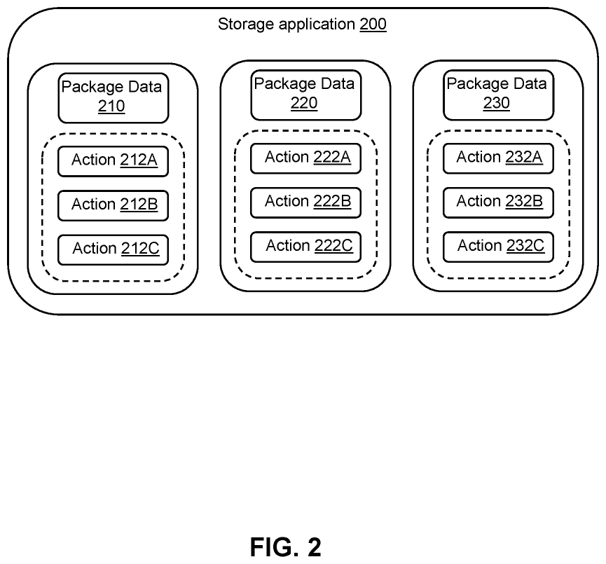

For example, FIG. 2 is an example of a storage application 200 storing one or more authorization packages of the user, according to some embodiments. For example, storage application 200 may include authorization package data (e.g., authorization package data 210, authorization package data 220, and authorization package data 230). Each of the authorization package data (e.g., authorization package data 210, authorization package data 220, and authorization package data 230) may include a token identifier, which enables the user to redeem or procure resources, such as value stored on a gift card, a time slot for an appointment, or one or more items, and/or the like. For example, the token identifier may indicate a string of alphanumeric characters, such as a unique identification number. In one example, the token identifier may be a gift card code, which is used to redeem the value of the gift card for goods or services. In another example, the token identifier may be a unique identifier that identifies an instance of an appointment reserved by the user.

According to some examples, the storage application may be used to display authorization package data to a user. For example, the user device 160 may obtain authorization package data (e.g., via communication subsystem 162) and generate, for display on graphic interface subsystem 164, authorization package data associated with the user and one or more actions corresponding to one or more authorization packages. The graphic interface subsystem 164 may show the user authorization package data (e.g., authorization package data 210, authorization package data 220, and authorization package data 230) and may also show a user one or more actions 212A-C, 222A-C, and 232A-C that may be performed using the package data. For example, in the case of a gift card, the actions may be to transfer the gift card to another user, to use the gift card at the entity device, to see more information such as a token identifier of the authorization package, and/or the like.

According to some examples, the processing system 110 may determine one or more attributes corresponding to the authorization packages. For example, the processing system 110 may determine (e.g., using determination subsystem 120 and/or machine learning subsystem 116) attributes such as a period of time during which the user is allowed to use the authorization package. In the example where the authorization package is a gift card, the attribute may be a period of time where the user is allowed to use the gift card to purchase one or more goods and/or services at the associated entity. Alternatively and/or additionally, the user device 160 may determine the one or more attributes using the authorization package data of the storage application. In response to determining that a value of the period of time is less than a threshold period of time, the user device may generate for display (e.g., via graphic interface subsystem 164) a recommendation for using the authorization package. For example, if a gift card is only valid for a month, and a threshold amount of time is left to use the gift card (e.g., a week), the system may generate a recommendation for display to the user, so that the user is aware. The threshold may be set by the user, or predetermined based on the entity, etc.

In some examples, when it is determined that user device 160 corresponding with the user is interacting with the entity device 130, a recommendation may be provided to the user for using the authorization package. For example, when a user is on a user's account on a platform of the entity (e.g., an online retailer), the system may provide to the user (e.g., via graphic interface subsystem 164 of user device 160), a recommendation to use an authorization package, such as a gift card on a purchase.

According to some examples, it may be determined that a user device 160 is corresponding with the user interacting with the entity device 130 when a user device 160 is within a physical location associated with the entity. For example, the user may enter a building such as a physical store with the user device 160. When the user device 160 comes within proximity of an entity device 130 within the store, the user device 160 may notify the user, or display to the user, one or more authorization packages from the storage application that may be used at the entity. For example, a user device 160 may display one or more gift cards, and/or store credit from returns, and/or other authorization packages that a user may use. User device 160 may also display a scannable code indicating the token identifier, such that the authorization package may be used at a point-of-sale system (POS system).

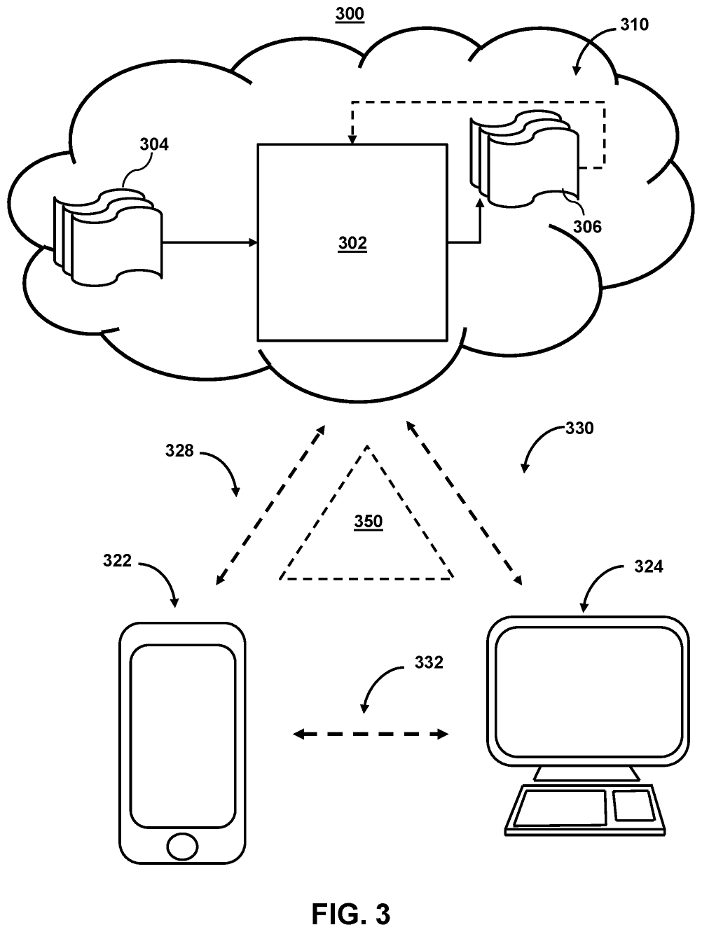

FIG. 3 shows illustrative components for a system used to process electronic messages, e.g., using machine learning, in accordance with one or more embodiments. For example, FIG. 3 may show illustrative components for enabling individual users to authenticate and/or procure resources, such as a time slot for an appointment, for one or more platforms, without the need for multiple interactions by the user and without necessitating several authentication steps between several parties. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, and/or mobile devices. FIG. 3 also includes cloud components 310.

Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include and/or access the processing system 110, entity device 130, remote server 140, and/or network 150.

Cloud components 310 may include model 302, which may be a machine learning model, artificial intelligence model, etc. (which may be referred to collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train the model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., determining an entity from at least a portion of an electronic message, identifying electronic messages that contain authorization packages, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem-solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., determining an entity from at least a portion of an electronic message, identifying electronic messages that contain authorization packages, etc.).

In some embodiments, the model (e.g., model 302) may automatically perform actions based on outputs 306. In some embodiments, the model (e.g., model 302) may not perform any actions. The output of the model (e.g., model 302) may be used to enable individual users to authenticate and/or procure resources, such as a time slot for an appointment, for one or more platforms, without the need for multiple interactions by the user and without necessitating several authentication steps between several parties.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a representational state transfer (REST) or web services API layer) may provide a decoupled interface to data and/or functionality of one or more applications. API layer 350 may provide a common, language-agnostic way of interacting with an application. Web service APIs offer a well-defined contract, called Web Services Description Language (WSDL), that describes the services in terms of its operations and the data types used to exchange information. REST APIs do not typically have this contract; instead, they are documented with client libraries for most common languages, including Ruby, Java, PHP, and JavaScript. Simple Object Access Protocol (SOAP) web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between front end and back end. In such cases, API layer 350 may use RESTful APIs (exposition to front end or even communication between microservices). API layer 350 may use Advanced Message Queuing Protocol (AMQP) (e.g., Kafka, RabbitMQ, etc.). API layer 350 may use incipient usage of new communications protocols such as gRPC, Thrift, etc.

According to some examples, the mobile device 322 and/or user terminal 324 may host the processing system 110 thereon. Additionally, or alternatively, the processing system 110 may be hosted on cloud components such as cloud components 310. In some examples, the processing system 110 may obtain electronic messages such as emails, e.g., stored in the mobile device 322 and/or user terminal 324. Alternatively and/or additionally, the processing system 110 may obtain the emails using cloud components. In some examples, processing system 110 may obtain the electronic messages and input the electronic messages to a local machine learning model. Alternatively or additionally, the electronic messages may be input into model 302, which may be hosted and executed on cloud components. The model 302 may determine electronic messages with authorization packages (e.g., emails with gift cards). For example, the output 306 of the model 302 may be a probability that electronic messages include authorization packages, and/or may simply be a determination that electronic messages include authorization packages. The command for executing an operation, such as describe herein, may be transmitted via the API layer 350, which may be identified using entity identification data.

In some embodiments, the system architecture may use an open API approach. In such cases, API layer 350 may use commercial or open source API Platforms and their modules. API layer 350 may use a developer portal. API layer 350 may use strong security constraints applying WAF and DDOS protection, and API layer 350 may use RESTful APIs as standard for external integration.

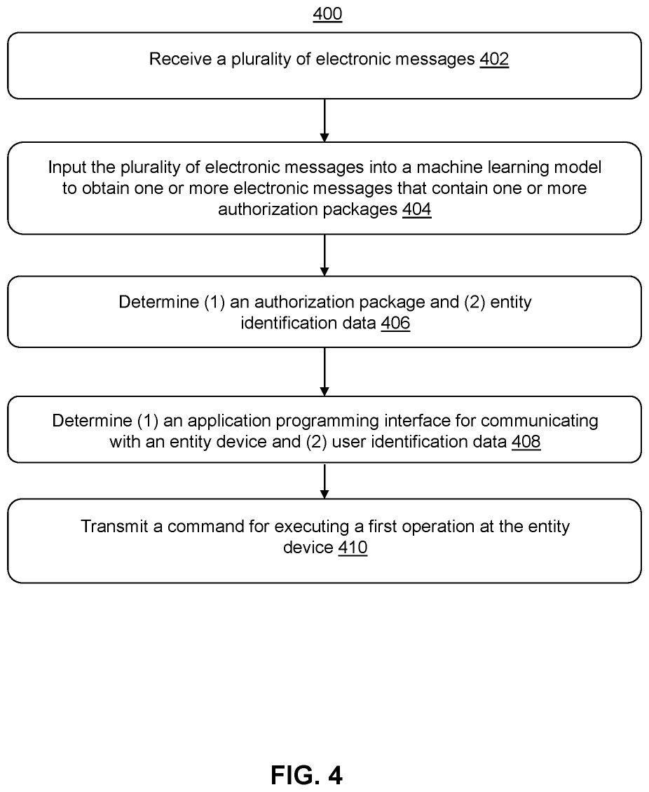

FIG. 4 shows a flowchart of the steps involved in a process 400 for processing electronic messages, in accordance with one or more embodiments. For example, the system may use process 400 (e.g., as implemented on one or more system components described above) in order to process electronic messages. The operations of FIG. 4 may use components described in relation to FIG. 3. In some embodiments, processing system 110 may include one or more components of system 300 and may be used to perform the steps of process 400.

At step 402, processing system 110 receives a plurality of electronic messages. For example, the processing system 110 may receive a plurality of electronic messages associated with a user, such as emails, text messages, instant messages, automated messages, etc. Processing system 110 may receive electronic messages from remote server 140.

At step 404, processing system 110 inputs the plurality of electronic messages into a machine learning model to obtain one or more electronic messages that contain one or more authorization packages. For example, the processing system 110 may input the plurality of electronic messages into a machine learning model to obtain one or more electronic messages of the plurality of electronic messages that contain one or more authorization packages for one or more entities, wherein the machine learning model is trained to identify electronic messages that contain authorization packages. In one example, processing system 110 may input the electronic messages into a machine learning model to obtain one or more electronic messages that include gift cards, vouchers, and/or the like.

In some examples, the process may include training the machine learning model. For example, the process may include receiving a training dataset comprising electronic messages and label data for each electronic message indicating (1) whether each electronic message includes a corresponding authorization package and (2) corresponding entity identification data and training the machine learning model using the training dataset.

In some examples, the process may include receiving an output of the machine learning model. The output of the machine learning model may include (1) a probability for each electronic message that each electronic message of the plurality of electronic messages includes at least one authorization package and (2) entity identification data associated with the at least one authorization package. In response to determining that the probability exceeds a threshold probability for an electronic message, the processing system 110 may determine that the electronic message of the plurality of electronic messages includes the at least one authorization package.

At step 406, processing system 110 determines (1) an authorization package and (2) entity identification data. For example, the processing system 110 may determine based on the one or more electronic messages (1) an authorization package comprising a token identifier, and (2) entity identification data identifying an entity associated with the authorization package. For example, for each email—the processing system may determine a gift card and an associated code, as well as the entity (e.g., online retailer) at which the gift card may be used.

In some examples, determining the entity identification data includes extracting textual data from an electronic message and performing OCR on the textual data. Alternatively, or additionally, determining the entity identification data includes generating an image from an electronic message, inputting the image into an entity recognition machine learning model to obtain the entity identification data, wherein the entity recognition machine learning model has been trained to identify entities associated with electronic messages, and receiving the entity identification data from the entity recognition machine learning model.

At step 408, processing system 110 determines (1) an application programming interface for communicating with an entity device and (2) user identification data. For example, the processing system 110 may determine, based on the entity identification data, (1) an application programming interface for communicating with an entity device and (2) user identification data used by the user to access the entity device.

At step 410, processing system 110 transmits a command for executing a first operation at the entity device. For example, the processing system 110 may transmit a command for executing a first operation at the entity device, wherein the command includes the user identification data and the authorization package in a format corresponding to the application programming interface. In some examples, the command includes an instruction for inserting the authorization package into user data of the user within the entity device and wherein the method further comprises generating the command for executing the first operation.

In some embodiments, the method may further include receiving, from the entity device, a message indicating that execution of the command was successful, wherein the message comprises a validity indicator for the authorization package, and generating for display at a user device, the validity indicator for the authorization package.

According to some embodiments, rather than inserting the authorization package into user data of the user within the entity device, e.g., inserting the gift card value or gift card code into a user's account at the entity, the processing system 110 may store the authorization package data on a storage application. For example, the system may initiate a storage application on a user device associated with the user, wherein the storage application is configured to store authorization package data of a plurality of authorization packages associated with the user and update the storage application with the authorization package.

The system may generate for display, using the storage application, (1) authorization package data of the plurality of authorization packages associated with the user and (2) one or more actions corresponding to one or more authorization packages.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for processing electronic messages, the method comprising: receiving, a plurality of electronic messages associated with a user; inputting the plurality of electronic messages into a machine learning model to obtain one or more electronic messages of the plurality of electronic messages that contain one or more authorization packages for one or more entities, wherein the machine learning model is trained to identify electronic messages that contain authorization packages; determining based on the one or more electronic messages (1) an authorization package comprising a token identifier, and (2) entity identification data identifying an entity associated with the authorization package; determining, based on the entity identification data, (1) an application programming interface for communicating with an entity device and (2) user identification data used by the user to access the entity device; and transmitting a command for executing a first operation at the entity device, wherein the command includes the user identification data and the authorization package in a format corresponding to the application programming interface.
2. The method of any of the preceding embodiments, wherein the command comprises an instruction for inserting the authorization package into user data of the user within the entity device and wherein the method further comprises generating the command for executing the first operation.
3. The method of any of the preceding embodiments, further comprising: receiving, from the entity device, a message indicating that execution of the command was successful, wherein the message comprises a validity indicator for the authorization package; and generating for display at a user device, the validity indicator for the authorization package.
4. The method of any of the preceding embodiments, further comprising: initiating a storage application on a user device associated with the user, wherein the storage application is configured to store authorization package data of a plurality of authorization packages associated with the user; and updating the storage application with the authorization package.
5. The method of any of the preceding embodiments, further comprising: generating for display, using the storage application, (1) authorization package data of the plurality of authorization packages associated with the user, and (2) one or more actions corresponding to one or more authorization packages.
6. The method of any of the preceding embodiments, further comprising: receiving one or more attributes corresponding to each of the one or more authorization packages of the storage application, wherein the one or more attributes include a period of time during which the user is allowed to use the authorization package; and in response to determining that a value of the period of time is less than a threshold period of time, generating for display a recommendation for using the authorization package.
7. The method of any of the preceding embodiments, further comprising: receiving an output of the machine learning model, wherein the output of the machine learning model comprises (1) a probability for each electronic message that each electronic message of the plurality of electronic messages includes at least one authorization package and (2) entity identification data associated with the at least one authorization package; and in response to determining that the probability exceeds a threshold probability for an electronic message, determining that the electronic message of the plurality of electronic messages includes the at least one authorization package.
8. The method of any of the preceding embodiments, further comprising: determining that a user device corresponding with the user is interacting with the entity device; and in response to determining that the user device is interacting with the entity device, generating for display, a recommendation to the user for using the authorization package.
9. The method of any of the preceding embodiments, further comprising: receiving a training dataset comprising electronic messages and label data for each electronic message indicating (1) whether each electronic message includes a corresponding authorization package and (2) corresponding entity identification data; and training the machine learning model using the training dataset.
10. The method of any of the preceding embodiments, wherein determining the entity identification data comprises: extracting textual data from an electronic message; and performing OCR on the textual data.
11. The method of any of the preceding embodiments, wherein determining the entity identification data comprises: generating an image from an electronic message; inputting the image into an entity recognition machine learning model to obtain the entity identification data, wherein the entity recognition machine learning model has been trained to identify entities associated with electronic messages; and receiving the entity identification data from the entity recognition machine learning model.
12. The method of any of the preceding embodiments, wherein determining the entity identification data comprises: extracting textual data from an electronic message; and performing OCR on the textual data.
13. A tangible, non-transitory, computer-readable medium storing instructions that, when executed by a data processing apparatus, cause the data processing apparatus to perform operations comprising those of any of embodiments 1-12.
14. A system comprising: one or more processors; and memory storing instructions that, when executed by the one or more processors, cause the processors to effectuate operations comprising those of any of embodiments 1-12.
15. A system comprising means for performing any of embodiments 1-12.
16. A system comprising cloud-based circuitry for performing any of embodiments 1-12.

What is claimed is:

1. A system for processing electronic messages, the system comprising:
one or more processors; and
a non-transitory, computer-readable storage medium storing instructions that when executed by the one or more processors cause the one or more processors to perform operations comprising:
receiving, a plurality of electronic messages associated with a user;
inputting the plurality of electronic messages into a machine learning model to obtain one or more electronic messages of the plurality of electronic messages that contain one or more authorization packages for one or more entities, wherein the machine learning model is trained to identify electronic messages that contain authorization packages;
extracting, from an electronic message of the one or more electronic messages (1) an authorization package comprising an authorization identifier, and (2) entity identification data identifying an entity associated with the authorization package;
determining, based on the entity identification data, (1) an application programming interface for communicating with an entity device and (2) user identification data used by the user to access the entity device;
generating a command for executing a first operation at the entity device for inserting the authorization package into user data within the entity device, wherein the command includes the user identification data for authorizing the user and the authorization package in a format corresponding to the application programming interface;
transmitting, via the application programming interface, the command to the entity device, wherein the entity device is configured to execute the first operation; and
receiving an indication of successful operation from the entity device.

2. A method for processing electronic messages, the method comprising:
receiving, a plurality of electronic messages associated with a user;
inputting the plurality of electronic messages into a machine learning model to obtain one or more electronic messages of the plurality of electronic messages that contain one or more authorization packages for one or more entities, wherein the machine learning model is trained to identify electronic messages that contain authorization packages;
determining based on the one or more electronic messages (1) an authorization package comprising a token identifier, and (2) entity identification data identifying an entity associated with the authorization package;
determining, based on the entity identification data, (1) an application programming interface for communicating with an entity device and (2) user identification data used by the user to access the entity device; and
transmitting a command for executing a first operation at the entity device, wherein the command includes the user identification data and the authorization package in a format corresponding to the application programming interface.

3. The method of claim 2, wherein the command comprises an instruction for inserting the authorization package into user data of the user within the entity device and wherein the method further comprises generating the command for executing the first operation.

4. The method of claim 3, further comprising:
receiving, from the entity device, a message indicating that execution of the command was successful, wherein the message comprises a validity indicator for the authorization package; and
generating for display at a user device, the validity indicator for the authorization package.

5. The method of claim 3, further comprising:
initiating a storage application on a user device associated with the user, wherein the storage application is configured to store authorization package data of a plurality of authorization packages associated with the user; and
updating the storage application with the authorization package.

6. The method of claim 5, further comprising:
generating for display, using the storage application, (1) authorization package data of the plurality of authorization packages associated with the user and (2) one or more actions corresponding to one or more authorization packages.

7. The method of claim 6, further comprising:
receiving one or more attributes corresponding to each of the one or more authorization packages of the storage application, wherein the one or more attributes include a period of time during which the user is allowed to use the authorization package; and
in response to determining that a value of the period of time is less than a threshold period of time, generating for display a recommendation for using the authorization package.

8. The method of claim 2, further comprising:
receiving an output of the machine learning model, wherein the output of the machine learning model comprises (1) a probability for each electronic message that each electronic message of the plurality of electronic messages includes at least one authorization package and (2) entity identification data associated with the at least one authorization package; and
in response to determining that the probability exceeds a threshold probability for an electronic message, determining that the electronic message of the plurality of electronic messages includes the at least one authorization package.

9. The method of claim 2, further comprising:
determining that a user device corresponding with the user is interacting with the entity device; and
in response to determining that the user device is interacting with the entity device, generating for display, a recommendation to the user for using the authorization package.

10. The method of claim 2, further comprising:
receiving a training dataset comprising electronic messages and label data for each electronic message indicating (1) whether each electronic message includes a corresponding authorization package and (2) corresponding entity identification data; and
training the machine learning model using the training dataset.

11. The method of claim 10, wherein determining the entity identification data comprises:
extracting textual data from an electronic message; and
performing optical character recognition on the textual data.

12. The method of claim 10, wherein determining the entity identification data comprises:
generating an image from an electronic message;
inputting the image into an entity recognition machine learning model to obtain the entity identification data, wherein the entity recognition machine learning model has been trained to identify entities associated with electronic messages; and
receiving the entity identification data from the entity recognition machine learning model.

13. A non-transitory, computer-readable medium storing instructions that, when executed by one or more processors, cause the one or more processors to perform operations comprising:
inputting a plurality of electronic messages associated with a user into a machine learning model to obtain one or more electronic messages of the plurality of electronic messages that contain one or more authorization packages for one or more entities, wherein the machine learning model is trained to identify electronic messages that contain authorization packages;
determining based on the one or more electronic messages (1) an authorization package comprising a token identifier, and (2) entity identification data identifying an entity associated with the authorization package;
determining, based on the entity identification data, (1) an application programming interface for communicating with an entity device and (2) user identification data used by the user to access the entity device; and
transmitting a command for executing a first operation at the entity device, wherein the command includes the user identification data and the authorization package in a format corresponding to the application programming interface.

14. The non-transitory, computer-readable medium of claim 13, wherein the command comprises an instruction for inserting the authorization package into user data of the user within the entity device and wherein the instructions cause the one or more processors to perform generating the command for executing the first operation.

15. The non-transitory, computer-readable medium of claim 14, wherein the instructions cause the one or more processors to perform operations comprising:
receiving, from the entity device, a message indicating that execution of the command was successful, wherein the message comprises a validity indicator for the authorization package; and
generating for display at a user device, the validity indicator for the authorization package.

16. The non-transitory, computer-readable medium of claim 14, wherein the instructions cause the one or more processors to perform operations comprising:
initiating a storage application on a user device associated with the user, wherein the storage application is configured to store authorization package data of a plurality of authorization packages associated with the user; and
updating the storage application with the authorization package.

17. The non-transitory, computer-readable medium of claim 16, wherein the instructions cause the one or more processors to perform operations comprising:
generating for display, using the storage application, (1) authorization package data of the plurality of authorization packages associated with the user and (2) one or more actions corresponding to one or more authorization packages.

18. The non-transitory, computer-readable medium of claim 17, wherein the instructions cause the one or more processors to perform operations comprising:
receiving one or more attributes corresponding to each of the one or more authorization packages of the storage application, wherein the one or more attributes include a period of time during which the user is allowed to use the authorization package; and
in response to determining that a value of the period of time is less than a threshold period of time, generating for display a recommendation for using the authorization package.

19. The non-transitory, computer-readable medium of claim 13, wherein the instructions cause the one or more processors to perform operations comprising:
receiving an output of the machine learning model, wherein the output of the machine learning model comprises (1) a probability for each electronic message that each electronic message of the plurality of electronic messages includes at least one authorization package and (2) entity identification data associated with the at least one authorization package; and
in response to determining that the probability exceeds a threshold probability for an electronic message, determining that the electronic message of the plurality of electronic messages includes the at least one authorization package.

20. The non-transitory, computer-readable medium of claim 13, wherein the instructions cause the one or more processors to perform operations comprising:
determining that a user device corresponding with the user is interacting with the entity device; and
in response to determining that the user device is interacting with the entity device, generating for display, a recommendation to the user for using the authorization package.
